(19) United States
(12) Patent Application Publication
(10) Pub. No.: US 2020/0382597 A1
(43) Pub. Date: Dec. 3, 2020

(54) VEHICLE DIAGNOSTIC COMMUNICATION APPARATUS, SYSTEM INCLUDING THE SAME AND METHOD THEREOF

(71) Applicants: HYUNDAI MOTOR COMPANY, Seoul (KR); KIA MOTORS CORPORATION, Seoul (KR)

(72) Inventor: Ho Jin JUNG, Seoul (KR)

(73) Assignees: HYUNDAI MOTOR COMPANY, Seoul (KR); KIA MOTORS CORPORATION, Seoul (KR)

(21) Appl. No.: 16/582,415

(22) Filed: Sep. 25, 2019

(30) Foreign Application Priority Data
May 28, 2019 (KR) 10-2019-0062741

(51) Int. Cl. H04L 29/08; H04L 12/66; G07C 5/00

(52) U.S. Cl. CPC H04L 67/12; G07C 5/008; H04L 12/66

(57) ABSTRACT

Disclosed are a vehicle diagnostic communication apparatus, a system including the same, and a method thereof. The vehicle diagnostic communication apparatus includes a communicator that performs control area network (CAN) communication in a multi-client diagnosis environment, and a processor that generates a communication message for a diagnosis request or a response based on an extended address-based CAN frame including a source address.

### CROSS-REFERENCE TO RELATED APPLICATION

The present application claims priority to and the benefit of Korean Patent Application No. 10-2019-0062741, filed on May 28, 2019, which is incorporated herein by reference in its entirety.

### TECHNICAL FIELD

The present disclosure relates to a vehicle diagnostic communication apparatus, a system including the same, and a method thereof, and more particularly, to a vehicle diagnostic service technique in a multi-client based diagnostic environment.

### BACKGROUND

The statements in this section merely provide background information related to the present disclosure and may not constitute prior art.

With the development of automobile electromagnetic and new technology, the number of vehicle internal controllers is continuously increasing. In addition, diagnostic information about the vehicle internal controller is read through various means in order to inform an external user of the information for diagnosing the vehicle.

Thus, when only one external diagnostic device via an existing OBD-II port has made diagnostic communication with an internal controller, various off/on board (vehicle inside/outside) equipment such as a telematics service (TMS), electric vehicle service equipment (EVSE: external vehicle charging equipment), and the like performs diagnostic communication with a vehicle diagnostic device.

However, in a vehicle not considering such various diagnostic devices, that is, a multi-client, a collision may occur in diagnostic communication, and an error may occur, so that it is impossible to obtain correct diagnostic information.

In a conventional vehicle, when an external diagnostic device comes in and requests a diagnostic message, the controller operating as a specific diagnostic client will stop it to the next ignition off (IG-Off) because it is impossible to determine the internal controller source in the multi-client diagnostic environment. In this case, during the corresponding cycle, other clients cannot perform diagnostic functions except for the external diagnostics.

In addition, when there are three or more clients, the clients cannot perform diagnostic communication with each other in either case except for an external diagnostic device. That is, diagnostic communication collision phenomenon occurs as soon as the diagnostic communication starts, so that, only a total of two diagnostic clients are allowed inside/outside the vehicle. However, this also causes a collision and it is impossible to perform the diagnosis service at the same time.

### SUMMARY

An aspect of the present disclosure provides a vehicle diagnostic communication apparatus which is capable of transmitting/receiving a communication message for a diagnosis request or a response by using a CAN communication frame based on CAN extended addressing to prevent CAN communication messages from colliding with each other and capable of performing diagnosis processing in order of priority which is preset among clients without stopping diagnosis when diagnosis is requested from multi-clients, a system including the same, and a method thereof.

In one aspect of the present disclosure, a vehicle diagnostic communication apparatus includes a communicator that performs control area network (CAN) communication in a multi-client diagnosis environment, and a processor that generates a communication message for a diagnosis request or a response based on an extended addressing-based CAN communication frame including a source address.

The processor may grasp a transmission client that makes the diagnosis request based on the source address included in the communication message when receiving the communication message for the diagnosis request from at least one of multi-clients.

The processor may transmit a first frame to the transmission client and receive a flow control from the transmission client.

The processor may perform a diagnosis and maintain a state in which a diagnosis request for another client is possible when receiving the communication message for the diagnosis request.

The processor may perform a diagnosis in order of priority when simultaneously receiving diagnosis requests from a plurality of clients or receiving a diagnosis request from another client while performing a previous diagnosis.

The vehicle diagnostic communication apparatus may further include storage that stores the priority for diagnosis processes for multi-clients.

The processor may set an external diagnostic device among the plurality of clients to a higher priority than an internal diagnostic device.

The processor may ignore a diagnosis request for a low-priority client when the low-priority client makes the diagnosis request while the diagnosis request is received from a high-priority client and processes a diagnosis.

The processor may allow the low-priority client to retransmit a communication message for a response or change the client to perform the diagnosis request to another client when the communication message for the response is not received within a preset time.

The extended addressing-based CAN communication frame may include a priority, an extended data page, a basic data page, a PDU format, a destination address, and a source address.

The extended addressing-based CAN communication frame may be composed of 29 bits, and a general addressing-based CAN communication frame is composed of 11 bits.

In another aspect of the present disclosure, a vehicle system includes a gateway that converts a general addressing-based CAN frame into an extended addressing-based CAN frame including a source address in a CAN communication based multi-client diagnosis environment, and a vehicle diagnostic communication apparatus that generates a communication message for a diagnosis request or a response based on the extended addressing-based CAN communication frame received from the gateway.

The gateway may store priority information in a 26-th bit to a 28-th bit of the extended addressing-based CAN frame by using information in an 8-th bit to a 9-th bit of the general addressing-based CAN frame, store a destination address in an 8-th bit to a 15-th bit of the extended addressing-based CAN frame by using information of a 0-th bit to a 7-th bit of the general addressing-based CAN frame, and convert the general addressing-based CAN frame into the extended addressing-based CAN frame.

The gateway may store ‘0 (zero)’ in a 24-th bit and a 25-th bit of the extended addressing-based CAN frame, store ‘218’ or ‘219’ in a 16-th to a 23-th bit, and store the source address in the 0-th bit to the 7-th bit. In another aspect of the present disclosure, a vehicle diagnostic communication method includes generating and transmitting a communication message for diagnosis request based on an extended addressing-based CAN communication frame including a source address in an CAN communication based multi-client diagnosis environment, and identifying a client that transmits the communication message based on the source address when receiving the communication message for the diagnosis request, and transmitting a response message to the client that transmits the communication message.

The vehicle diagnostic communication method may further include converting a general addressing-based CAN frame into the extended addressing-based CAN frame when receiving the general addressing-based CAN frame for the diagnosis request.

The vehicle diagnostic communication method may further include performing a diagnosis in order of priority when simultaneously receiving diagnosis requests from a plurality of clients or receiving a diagnosis request from another client while performing a previous diagnosis when receiving the communication message for the diagnosis request.

The vehicle diagnostic communication method may further include storing the priority for the multi-client in advance.

Performing the diagnosis in the order of the priority may include ignoring a diagnosis request for a low-priority client when the low-priority client makes the diagnosis request while the diagnosis request is received from a high-priority client and a diagnosis is performed.

Performing the diagnosis in order of priority may include retransmitting a communication message for a response or changing, by the low-priority client, the client to perform the diagnosis request to another client when the communication message for the response is not received within a preset time.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a configuration of a vehicle system including a vehicle diagnostic communication apparatus in one form of the present disclosure;

FIG. 2 is a view illustrating a detailed configuration of a vehicle diagnostic communication apparatus in one form of the present disclosure;

FIG. 3 is an exemplary diagram illustrating a general addressing-based frame and an extended addressing-based frame in one form of the present disclosure;

FIG. 4 is an exemplary diagram illustrating details of an identifier of an extended addressing-based message in one form of the present disclosure;

FIG. 5 is an exemplary diagram illustrating a scheme of converting a general addressing-based message into an extended addressing-based message in one form of the present disclosure;

FIG. 6 is a table showing types of source address based diagnostic devices in one form of the present disclosure;

FIG. 7 is a table illustrating an example of setting priorities for each client in one form of the present disclosure;

FIG. 8 is a flowchart illustrating a vehicle diagnostic communication method in one form of the present disclosure; and

FIG. 9 is a block diagram illustrating a computing system in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In describing the components in some forms of the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

According to the present disclosure, diagnostic communication is performed using a CAN communication frame based on 29-bit extended addressing (CAN extended addressing) including source information of a client requesting diagnosis, thereby preventing collision of diagnostic communication messages. In addition, disclosed is a technology for providing a diagnostic service in accordance with a client priority by switching to an extended address scheme without stopping a diagnosis request even if a diagnostic message is received in an existing general address scheme.

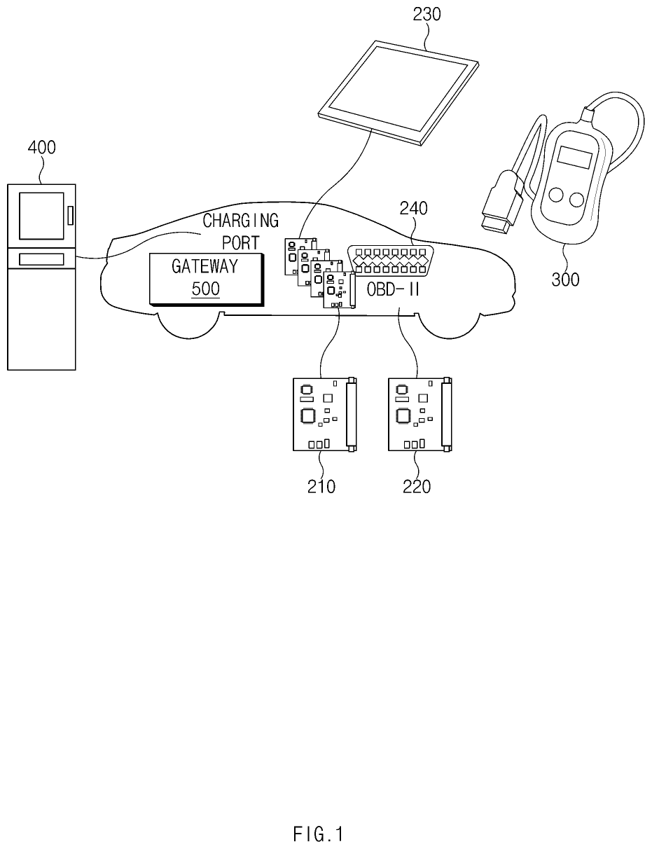

Hereinafter, some forms of the present disclosure will be described in detail with reference to FIGS. 1 to 9.

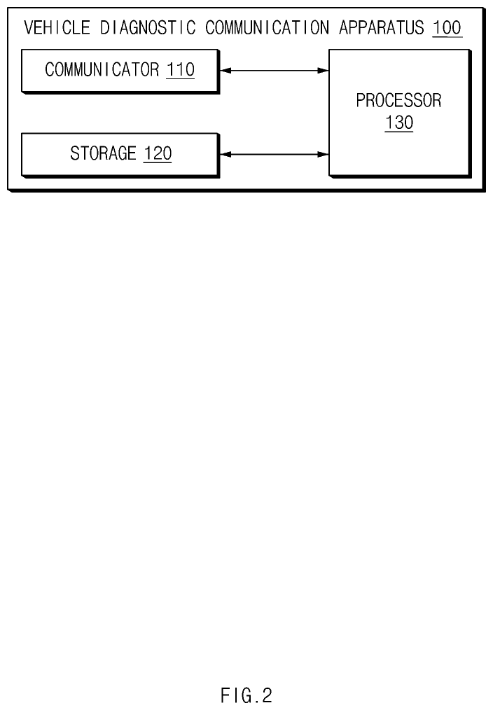

FIG. 1 is a block diagram illustrating a configuration of a vehicle system including a vehicle diagnostic communication apparatus in some forms of the present disclosure. FIG. 2 is a view illustrating a detailed configuration of a vehicle diagnostic communication apparatus in some forms of the present disclosure.

Referring to FIG. 1, a vehicle system in some forms of the present disclosure may include a configuration for performing a vehicle diagnosis based on multi-clients, and may include internal diagnostic devices 210 and 220, a vehicle internal controller 230, an external diagnostic device 300 outside the vehicle, an electric vehicle supply equipment (EVSE) 400 capable of requesting a diagnosis from an outside of the vehicle, and a gateway 500, as multi-clients. In this case, the internal diagnostic devices 210 and 220, the vehicle internal controller 230, the external diagnostic device 300, the EVSE 400, and the like may be included. In this case, each of the multi-clients may request a diagnosis or respond to the diagnosis request.

The internal diagnostic devices 210 and 220, the vehicle internal controller 230, the external diagnostic device 300, the EVSE 400 and the like may request a vehicle diagnosis to each other, receive a response thereto, and transmit a response to a diagnosis request when receiving the diagnosis request.

The internal diagnostic devices 210 and 220 may make a vehicle diagnosis request to the vehicle internal controller 230 or another internal diagnostic device.

The vehicle internal controller 230 may include an electronic control unit (ECU) such as a telematics terminal, an audio video navigation (AVN), and the like.

The external diagnostic device 300, which is a portable diagnostic device for communication diagnosis, may request a vehicle diagnostic service to the internal diagnostic devices 210 and 220, the vehicle internal controller 230, and the like.

The EVSE 400, which is a charging device of a charging station, may request the vehicle diagnostic service to the internal diagnostic devices 210 and 220, the vehicle internal controller 230, and the like.

When receiving a general address type communication message, the gateway 500 converts the general address type communication message into an extended address type communication message and transmits the extended address type communication message to a target controller or a diagnostic device.

In this case, the external diagnostic device 300 is connected to a communication port (OBD-II) 240 for diagnosis. The communication port 240, which is a connector called a diagnostic link connector (DLC), is formed with a total of 16 pins.

A vehicle diagnostic communication apparatus 100 shown in FIG. 2, which is an apparatus for receiving and responding to a vehicle diagnosis request message, may be at least one of the internal diagnostic devices 210 and 220, the vehicle internal controller 230, the external diagnostic device 300 outside the vehicle, and the EVSE 400.

When receiving a diagnosis request from at least one of the internal diagnostic devices 210 and 220, the vehicle internal controller 230, the external diagnostic device 300 outside the vehicle, and the EVSE 400, the vehicle diagnostic communication apparatus 100 transmits diagnostic information thereof. In this case, the vehicle diagnostic communication apparatus 100 may generate a communication message for requesting or responding to diagnosis based on the extended addressing-based CAN communication frame including the source address.

Referring to FIG. 2, the vehicle diagnostic communication apparatus 100 may include a communicator 110, storage 120, and a processor 130.

The communicator 110 may perform intra-vehicle communication through CAN communication, LIN communication, or the like, and may perform communication with the multi-clients.

The storage 120 may store priority information for processing diagnostic services for clients. The storage 120 may include at least one type of a storage medium of memories of a flash memory type, a hard disk type, a micro type, a card type (e.g., a secure digital (SD) card or an extreme digital (XD) card), and the like and a random access memory (RAM), a static RAM (SRAM), a read-only memory (ROM), a programmable ROM (PROM), an electrically erasable PROM (EEPROM), a magnetic disk, and an optical disk type memory.

The processor 130 may be electrically connected to the communicator 110, the storage 120, and the like, may electrically control each configuration, and may be an electric circuit for executing commands of software. Thus, the processor 130 may perform various data processing and calculations described below.

The processor 130 may generate a communication message for requesting or responding to a diagnosis based on the extended address-based CAN communication frame including the source address of the client that has transmitted a diagnostic request.

When the processor 130 receives the communication message for the diagnosis request from at least one of the multi-clients, the processor 130 may identify the transmission client that has requested the diagnosis based on the source address included in the communication message.

The processor 130 may transmit a first frame (FF) to the transmission client that is identified based on the source information, and may receive flow control (FC) from the transmission client. In this case, the CAN communication message basically uses up to 8 bytes for data, and uses a CAN transport protocol (TP) message for transmitting data of 8 bytes or more. When the amount of data to be transmitted is 8 bytes or less, the data may be transmitted through a single frame (SF) message. When the amount of data exceeds 8 bytes, the data may be transmitted by using a combination of a first frame (FF) message, a flow control (FC) message, and a consecutive frame (CF) message.

The receiving controller, which receives the first-time first frame message, transmits a flow control message as a response message to the transmission controller, such that the receiving controller provides the transmission controller with information on how much data to transmit at one time and at what interval. Thus, the transmission controller transmits a consecutive frame message to the receiving controller for the remaining data to be transmitted. In this case, a frame means a field or a set of bits constituting one message, a data frame means a data message to be transmitted, and a flow control message performs a function of flow control to overcome a speed difference between points.

When the processor 130 receives the communication message for the diagnosis request, the processor 130 may perform the diagnosis and maintain the state where the diagnosis request for the other clients is possible. According to the related art, it is impossible to request diagnosis for other clients in the state where a diagnosis request was received.

When the processor 130 receives diagnosis requests from a plurality of clients at the same time, or receives a diagnosis request from another client while performing a previous diagnosis, the processor 130 may perform a diagnosis in order of priority.

The processor 130 may set an external diagnostic device among a plurality of clients to have a higher priority than an internal diagnostic device. While a diagnosis request is received from a client having a higher priority and a diagnosis process is performed, when a diagnosis request is received from a client having a lower priority, the processor 130 may ignore the diagnosis request of the client having a lower priority.

In case of a client having a low priority, when a communication message for a response is not received for a preset time, the processor 130 may retransmit the diagnosis request or change the client to perform a diagnosis request to another client.

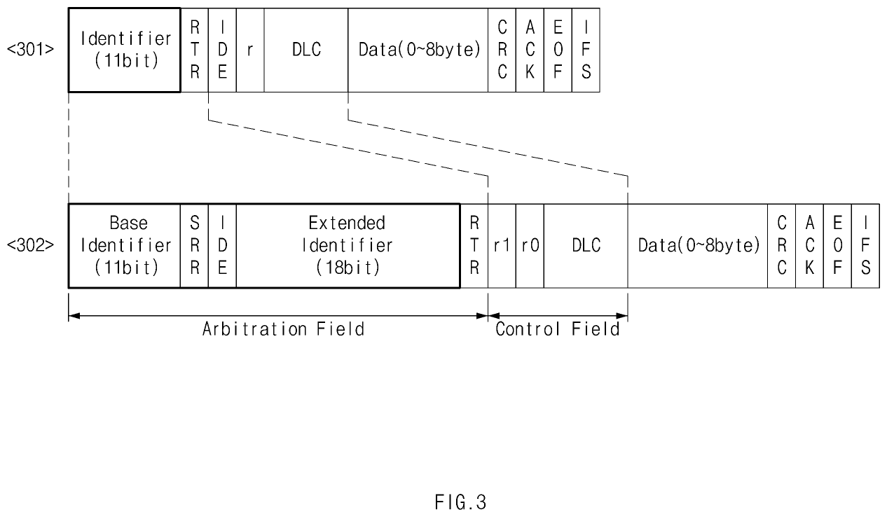

FIG. 3 is an exemplary diagram illustrating a general addressing-based frame and an extended addressing-based frame in some forms of the present disclosure. In FIG. 3, reference numeral 301 denotes a structure of a general addressing-based frame, and reference numeral 302 denotes a structure of an extended addressing-based frame.

The CAN communication message includes protocol control information (PCI), information for distinguishing messages, data, and actual payload data. In the present disclosure, referring to reference numeral 301 of FIG. 3, the general addressing-based frame has an identifier of 11 bits in size. The general address based frame may be used in a range of 0x000h to 0x7FFh, and a message for a diagnosis service may be used in a range of 700h to 7FFh. In this case, two messages for request/response are allocated to each controller, and a total of 127 messages may be used.

The start of frame (SOF) is used to mark the start of a message with a single dominant SOF dominant (logic 0) bit and to synchronize the nodes on the bus after a no-load period. The identifier identifies the message and an 11-bit arbitration ID is used for the frame. The RTR is a single remote transmission request (RTR) bit that serves to distinguish a remote frame from a data frame. The dominant (logic 0) RTR bit represents the data frame and the recessive (logic 1) RTR bit represents the remote frame. The IDE may distinguish between a dominant single identifier extension (IDE) standard and an extended frame. The ‘r0’ represents an inverse bit. The data length code (DLC), which is 4 bits, indicates the number of bytes of the data field. In this case, the identifier means an arbitration field, and the IDE˜R0 and DLC mean a control field (6 bits).

The data may be transmitted up to 64 bits of application data, and cyclic redundancy check (CRC) consists of a periodic redundancy check code of 15 bits and a recessive delimiter bit. The CRC field may be used for error detection. Every CAN controller that has correctly received an ACK-message transmits an ACK bit at the end of a message. The transmitting node may identify the existence of the ACK bit on the bus and may retry the transmission when no ACK is found.

EOF, which is a 7-bit field of end of frame (EOF), indicates the end of the CAN frame (message). The inter-frame space (IFS) is 7 bits and contains the amount of time the controller requests.

Referring to 302 of FIG. 3, the extended addressing-based TP message is extended to 29 bits corresponding to the identifier of the general addressing-based TP message. That is, the extended addressing-based TP message may include a basic identifier, SRR, IDE, extended identifier, RTR, r, DLC, and the like.

In this case, the extended addressing-based TP message may be used up to 0xFFh (8 bits/1 byte) based on ISO15765-2 normal fixed address standard, and up to 256 TP messages may be used. In this case, the extended addressing-based TP message has a source address and a target address.

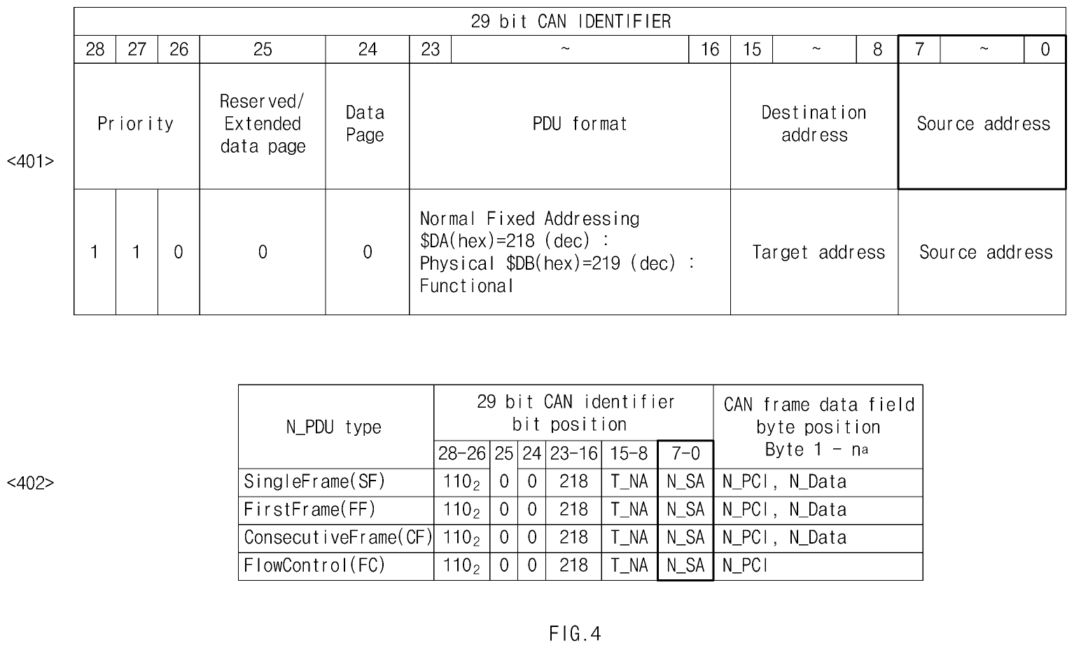

FIG. 4 is an exemplary diagram illustrating details of an identifier of an extended addressing-based message in some forms of the present disclosure.

Referring to reference numeral 401 of FIG. 4, the 29-bit CAN identifier includes a source address of 0 to 7 bits, a destination address of 8 to 15 bits, a protocol data unit (PDU) format of 16 to 23 bits, a data page at 24 bit, a reserved/extended data page at 25 bit, and a priority at 26 bit, 27 bit, and 28 bit.

That is, in the general address system, all 11 bits are used as an identifier, but in the extended address system, different meanings are given for each bit. In particular, referring to tables 401 and 402 of FIG. 4, the tables include a source address, so that the reception controller may know the transmission controller.

In the CAN communication, an ID is assigned to each message. In this case, the 11-bit general addressing scheme and the 29-bit extended addressing scheme are used, and 11-bit is mainly used. Diagnostic CAN ID is assigned to 700˜in the 11 bits. The diagnostic CAN ID may be allocated to 0x700˜0x7FF in 11-bit structure, so that ‘254’ may be used except for functional addressing. Thus, ‘254’ is divided by the request/response for each ID, and diagnostic IDs may be assigned to the total of 127 controllers.

However, since the number of controllers is rapidly increasing as the number of new technologies increases, it is practically impossible to give different IDs to all clients. For example, when there are 100 controllers in a vehicle and four internal diagnostics, a total of 400 IDs (total 800 including request/response) are required to identify the controllers. This is because the CAN message of the general address type includes only the destination address, and therefore the controller receiving a diagnosis request cannot identify where the message comes from. In reality, it is impossible to secure the number to allocate them. Therefore, when a multi-frame process is performed, a diagnosis conflict may occur with respect to multi-clients, so that the correct diagnosis information may not be transmitted.

Accordingly, in the present disclosure, a response message is transmitted only to a controller that has transmitted using a 29-bit extended addressing-based communication message including a source address and a target address, and a diagnostic service may be performed corresponding to the priority of each diagnostic device.

However, when a diagnosis request is received from an external diagnostic device using a general address scheme, it is necessary to convert a general addressing-based frame into an extended addressing-based frame.

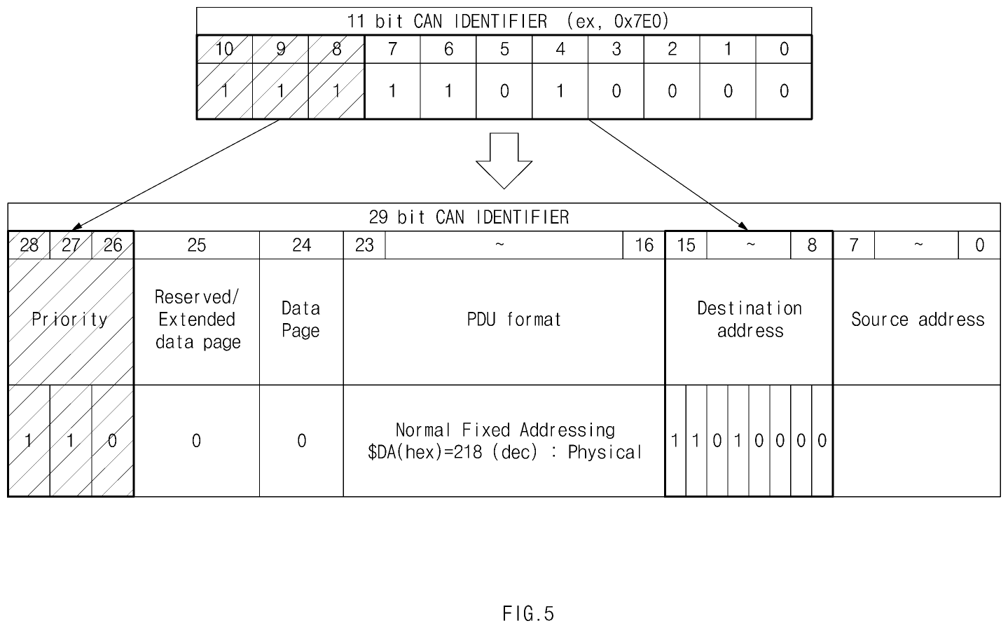

FIG. 5 is an exemplary diagram illustrating a scheme of converting a general addressing-based message into an extended addressing-based message in some forms of the present disclosure.

When a general address type message and an extended address type message are used while being mixed, for example, a diagnostic device connected to a vehicle may apply an extended addressing scheme to the controller 230 connected to the vehicle, that is, a telematics terminal or an internal ECU diagnosis (e.g., GW) to perform diagnostic communication. However, in case of an external diagnostic device (OBD legal diagnostic device 300, EVSE charging diagnostic device 400, etc.) belonging to a diagnostic infrastructure connected to an outside of the vehicle, the external diagnostic device exists out of control of OEM, so that the generic addressing scheme may be used.

In this case, because there is no difference between the payload size and the data rate in the general addressing scheme and the extended addressing scheme, the gateway (CGW or charging controller) communicating with an outside may convert a general addressing-based communication message into an extended addressing-based communication message as shown in FIG. 5.

Referring to FIG. 5, in case of the general address type diagnostic message, the first three bits are unconditionally set to ‘7 (111)’. Thus, the gateway 500 changes ‘7 (111)’ to ‘6 (110)’ in the extended addressing scheme, and 25-th bit and 24-th bit are filled with ‘0 (zero)’.

In case of the 11-bit general addressing scheme, because the function address to be transmitted as a whole is fixed to 0x7DF, when the corresponding ID is found, the PDU format is changed to $ DB (219 dec). When any other IDs are found, the format is unconditionally changed to $ DA (218 dec) and filled with a value. That is, when the function address, which is from 16 bits to 23 bits of the diagnostic message in the extended addressing scheme has 0x7DF, the frame is filled with 219, otherwise, filled with 218. In addition, the destination address from 0 to 7 bits of the general address scheme is filled into 8-th bit to 15-th bit of the extended addressing message.

Thereafter, the gateway 500 fills 0˜7 bits, which is a source address, with a source address specified corresponding to the priority of each controller. For example, the source address is set to 0x0A in case of CGW connected to D-CAN to which the OBD or OEM diagnostic device is connected and filled with 0x0B in case of the charging controller applied through a diagnosis additional service of an external charger. Then, the source address may be routed to an internal domain.

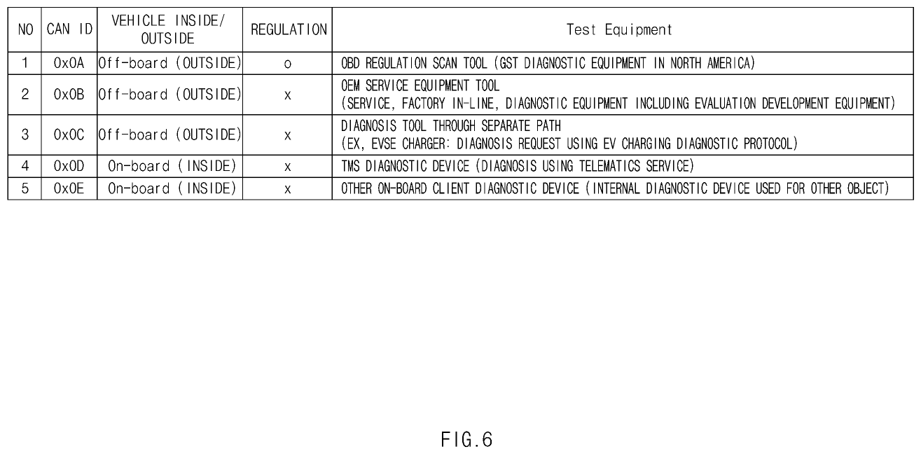

FIG. 6 is a table showing types of source address based diagnostic devices in some forms of the present disclosure.

Referring to FIG. 6, the vehicle diagnostic communication apparatus 100 may identify the diagnostic device that has transmitted the diagnostic message based on the source address of the message converted into the extended address.

In FIG. 6, five diagnostic devices are taken as an example, and the vehicle diagnostic communication apparatus 100 may prioritize and store the priority of each diagnostic device in advance according to a situation.

When introducing the priority concept, the vehicle diagnostic communication apparatus 100 may not need additional resource management and may process the diagnosis request message corresponding to the priority order among the diagnostic devices without collision of diagnosis requests.

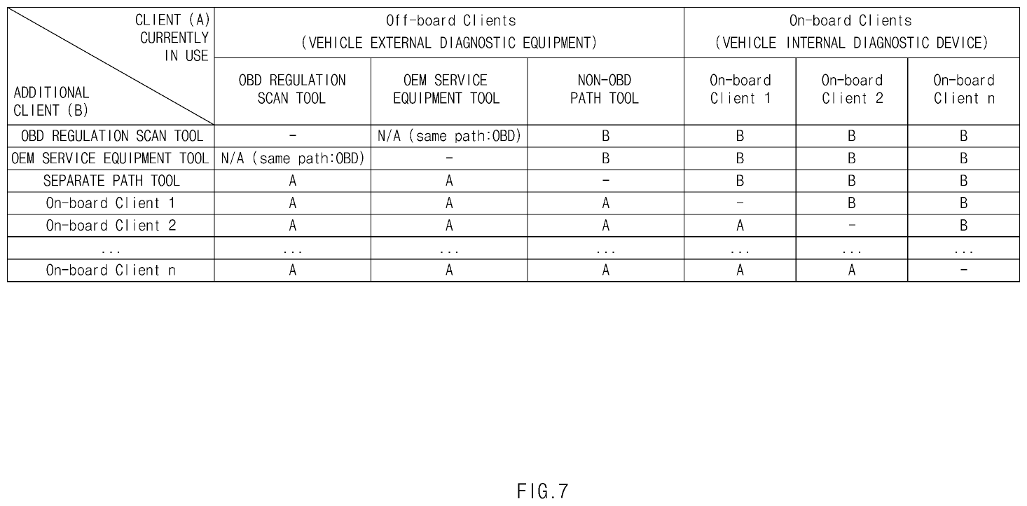

FIG. 7 is a table illustrating an example of setting priorities for each client in some forms of the present disclosure.

Referring to FIG. 7, an example in which priority is set according to a situation is disclosed.

For example, when a client ‘A’ currently in use is an external diagnostic device for a vehicle and a client ‘B’ that has made an additional diagnosis request is an internal diagnostic device, it may be known that the external diagnostic device has priority.

As shown in FIG. 7, the priority of each client (the diagnostic device, the controller, and the like) may be set, and the controller may process or stop the diagnosis request corresponding to the priority of each client.

As a first example, while a diagnosis request is received from a high-priority diagnostic device (e.g., an external diagnostic device) and the diagnosis request is processed, when a diagnosis request is received from a low-priority diagnostic device (e.g., an internal diagnostic device), the low-priority diagnostic device is ignored. In this case, when the low-priority diagnostic device detects no response during P2max timeout (e.g., 50 ms), the low-priority diagnostic device may recognize that its message is ignored and may re-transmit the diagnosis request or may change the target controller and request the diagnostic service to another controller.

As a second example, while a diagnosis request is received from a low-priority diagnostic device (e.g., an internal diagnostic device) and the diagnosis request is processed, when a diagnosis request is received from a high-priority diagnostic device (e.g., an external diagnostic device), after stopping the current processing diagnosis request (from an internal diagnostic device) through a dedicated timing behavior for a high-priority external diagnostic device, the controller processes the diagnosis request of the high-priority. In this case, the client may retransmit the diagnosis request or change the target controller without any error processing and may continue to request the diagnostic service without stopping.

As described above, according to the present disclosure, by using the extended addressing scheme (29-bit CAN ID system), information about a source address and a target address is included in the CAN ID, so that the vehicle diagnostic communication apparatus which receives the extended addressing diagnostic message may transmit a response message only to the controller or diagnostic device that has transmitted the extended addressing diagnostic message.

Even when transmitting a TP message, that is, a first frame message, in which a collision has occurred in a conventional scheme, as well as a general single frame response, the first frame message is transmitted only to the diagnostic device requesting a diagnosis request, so that flow control message reception collision does not occur.

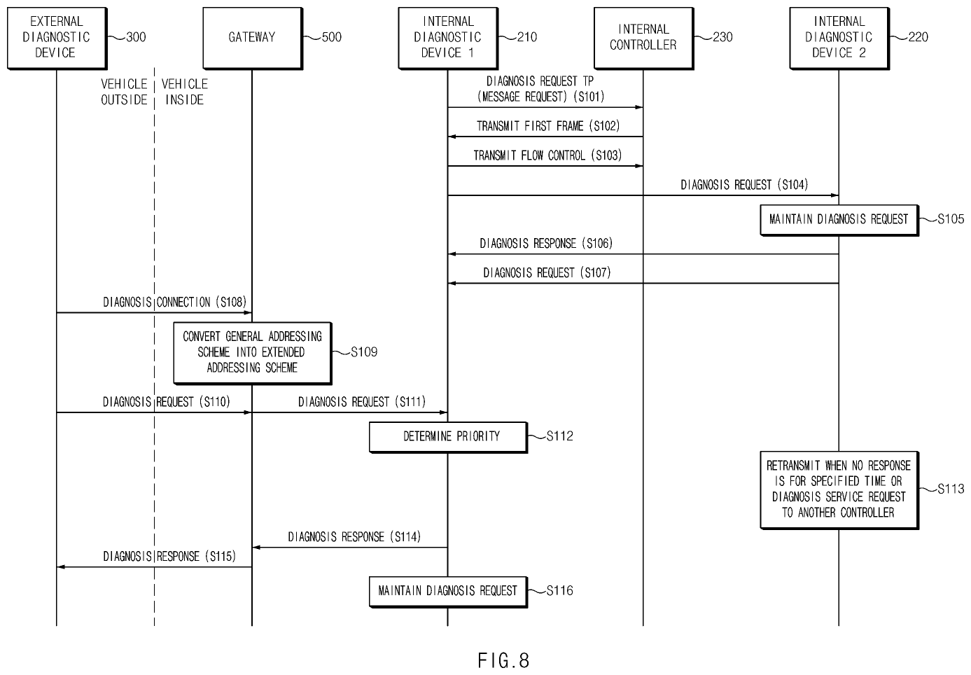

Hereinafter, a vehicle diagnostic communication method in some forms of the present disclosure will be described in detail with reference to FIG. 8. FIG. 8 is a flowchart illustrating a vehicle diagnostic communication method in some forms of the present disclosure.

Hereinafter, it is assumed that the vehicle internal diagnostic devices 210 and 220 and the vehicle internal controller 230 in FIG. 1 perform a vehicle diagnostic communication process. In addition, it may be understood that the operations described as being performed by the vehicle internal diagnostic devices 210 and 220 and the vehicle internal controller 230 are controlled by the processor 130 of the vehicle diagnostic communication apparatus 100. In this case, it is assumed that the priorities are set in the order of the external diagnostic device 300, the internal diagnostic device ‘1’ 210, and the internal diagnostic device ‘2’ 220.

Referring to FIG. 8, when the internal diagnostic device 210 transmits a diagnostic message of requesting diagnosis to the internal controller 230 in S101, the internal controller 230 uses the source address in the diagnostic message to transmit the first frame (FF) to the internal diagnostic device ‘1’ 210 that has transmitted the diagnosis message, in S102.

In S103, the internal diagnostic device ‘1’ 210 transmits the flow control (FC) in response to the first frame.

That is, according to the related art, because the source information is not included in the diagnostic message for the diagnosis request, the first frame is transmitted to all the vehicle internal controller and another diagnostic device ‘2’ 220 in a broadcasting scheme, so that the vehicle internal controller and the another diagnostic device ‘2’ 220 output control first, respectively, thereby resulting in collision of control first. Therefore, according to the related art, it is designed to stop the diagnosis request when the internal diagnostic device itself receives the diagnosis request.

In the present disclosure, the vehicle internal controller 230 that has received the diagnostic message for diagnosis request may identify the transmission subject that has transmitted the diagnostic message, based on the source address, and may transmit the first frame only to the internal diagnostic device ‘1’ 210 without transmitting the first frame to another controller or the another diagnostic device ‘2’ 220, such that only the internal diagnostic device ‘1’ 210 receives the flow control, thereby preventing the flow control conflict that occurs in receiving the flow controls from all the diagnostic devices or controllers.

Meanwhile, when the internal diagnostic device ‘1’ 210 transmits a diagnostic message for the diagnosis request to the internal diagnostic device ‘2’ 220, in a state in which the diagnosis request is maintained in S105, the internal diagnostic device ‘2’ 220 transmits a diagnosis message for diagnosis response to the internal diagnostic device ‘1’ 210 in S106.

Meanwhile, when the internal diagnostic device ‘2’ 220 makes a diagnosis request to the internal diagnostic device ‘1’ 210 in S107 while the internal diagnostic device ‘1’ 210 performs a diagnosis, in S112, the internal diagnostic device ‘1’ 210 determines the priority when receiving a diagnosis request from the external diagnostic device 300. That is, the external diagnostic device 300 performs diagnostic connection to the gateway 500 in S108, and the gateway 500 converts the general addressing format of the diagnostic message into the extended addressing format in S109.

Thereafter, when the external diagnostic device 300 makes a diagnosis request in S110 and S111, the internal diagnostic device ‘1’ 210 determines the priority between the external diagnostic device 300 and the internal diagnostic device ‘2’ 220 which has made a diagnosis request immediately before the diagnosis request and performs a diagnosis response with the external diagnostic device 300 having the higher priority in S114 and S115. In this case, the internal diagnostic device ‘1’ 210 performing a diagnosis maintains the diagnosis request in S116.

Meanwhile, when there is no response from the internal diagnostic device ‘1’ 210 for a specified time although the internal diagnostic device ‘2’ 220 requests a diagnosis to the internal diagnostic device ‘1’ 210 in step S107, the internal diagnostic device ‘2’ 220 may re-transmit the diagnosis request or change the target to request the diagnosis to another controller or another diagnostic device in S113.

As described above, in the conventional general addressing system (11 bits), because there is no source information, the controller receiving the diagnosis request transmits the first frame to all the diagnostic devices when transmitting the multi-frame. In this case, all the diagnostic devices connected to the vehicle controller transmit the flow control, thereby causing the reception controller to generate an error due to the TP message collision. Accordingly, according to the present disclosure, the extended addressing method (29 bits) is used to distinguish the source address and the target address, so that the TP message (flow control) is transmitted only to the diagnostic device that has made a diagnosis request to itself, thereby preventing the TP message collision.

In addition, in the case of the vehicle external diagnostic device (e.g., an OBD regulation diagnostic device, an EVSE charge diagnostic device, and the like) which cannot be controlled by the OEM, the general addressing scheme may be used instead of the extended addressing. Therefore, according to the present disclosure, by converting the general address into the extended address, both the general addressing and the extended addressing may be usable while being mixed.

In addition, according to the present disclosure, the priorities of clients connected in the vehicle may be defined in advance, thereby making it possible to perform or stop the diagnosis request corresponding to the priorities, from the diagnostic device having the higher priority to the diagnostic device having the lower priority.

As described above, according to the present disclosure, a multi-client environment may be available in comparison with the related art. Instead of activating only one diagnostic device, all the diagnostic devices may perform the diagnostic request service corresponding to the priority without stopping. Further, according to the present disclosure, the technology may be applied only by a simple modification procedure of the TP structure of the ECU software without replacing specific hardware such as a microcomputer or a memory, thereby minimizing the burden of increasing the cost.

In a conventional vehicle, when an external diagnostic device comes in and requests a diagnostic message, the controller operating as a specific diagnostic client will stop it to the next ignition off (IG-Off) because it is impossible to determine the internal controller source in the multi-client diagnostic environment. As a result, during the cycle, other clients cannot perform diagnostic functions except for the external diagnostic devices. Therefore, according to the present disclosure, it is not necessary to stop the diagnosis request service by setting priorities of the multi-clients in advance and performing diagnosis corresponding to the priorities.

In addition, according to the present disclosure, even when a large number of clients request a diagnosis regardless of the number of clients, the reliability of the diagnostic processing service may be improved by processing the diagnosis sequentially corresponding to the priorities.

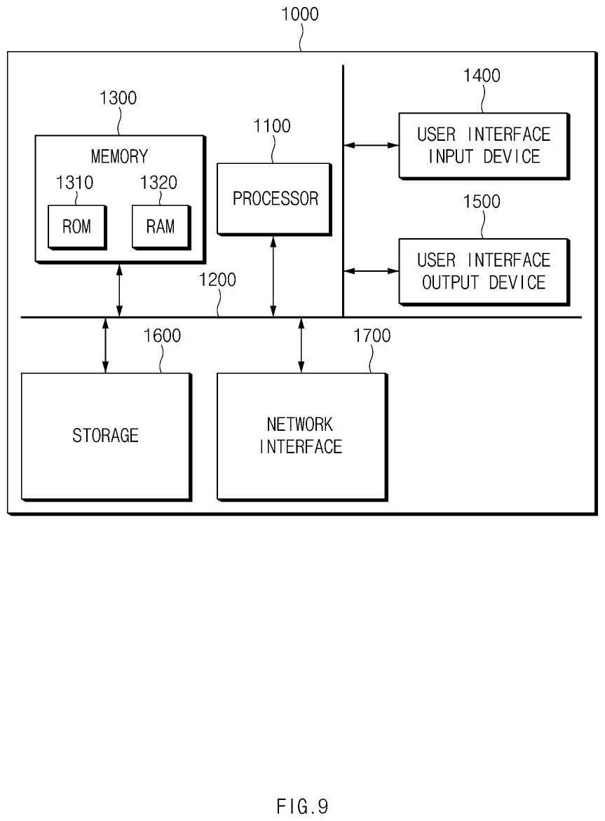

FIG. 9 is a block diagram illustrating a computing system in some forms of the present disclosure.

Referring to FIG. 9, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory).

Thus, the operations of the method or the algorithm described in some forms of the present disclosure may be embodied directly in hardware or a software module executed by the processor 1100, or in a combination thereof. The software module may reside on a storage medium (that is, the memory 1300 and/or the storage 1600) such as a RAM memory, a flash memory, a ROM memory, an EPROM memory, an EEPROM memory, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

According to the present disclosure, it is possible to prevent CAN communication messages from colliding with each other by transmitting/receiving a communication message for a diagnosis request or a response by using a CAN communication frame based on CAN extended addressing and to perform diagnosis processing in order of priority which is preset among clients without stopping diagnosis when diagnosis is requested from multi-clients.

In addition, various effects that are directly or indirectly understood through the present disclosure may be provided.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A vehicle diagnostic communication apparatus comprising:
a communicator configured to perform control area network (CAN) communication in a multi-client diagnosis environment; and
a processor configured to generate a communication message for a diagnosis request based on an extended address-based CAN frame including a source address.

2. The vehicle diagnostic communication apparatus of claim 1, wherein the processor is configured to:
identify a transmission client that makes the diagnosis request based on the source address included in the communication message when receiving the communication message from at least one client.

3. The vehicle diagnostic communication apparatus of claim 2, wherein the processor is configured to:
transmit, to the transmission client, a first frame; and
receive, from the transmission client, a flow control.

4. The vehicle diagnostic communication apparatus of claim 1, wherein the processor is configured to:
perform a diagnosis and maintain a state in which a diagnosis request for another client is possible when receiving the communication message.

5. The vehicle diagnostic communication apparatus of claim 1, wherein the processor is configured to:
perform the diagnosis in order of priority when simultaneously receiving diagnosis requests from a plurality of clients or receiving a diagnosis request from the another client while performing a previous diagnosis.

6. The vehicle diagnostic communication apparatus of claim 5, further comprising:
a storage configured to store the priority for diagnosis processes for multi-clients.

7. The vehicle diagnostic communication apparatus of claim 5, wherein the processor is configured to:
set an external diagnostic device among the plurality of clients to a higher priority than an internal diagnostic device.

8. The vehicle diagnostic communication apparatus of claim 5, wherein the processor is configured to:
disregard a diagnosis request for a low-priority client when the low-priority client makes the diagnosis request while the diagnosis request is received from a high-priority client and processes a diagnosis.

9. The vehicle diagnostic communication apparatus of claim 8, wherein the processor is configured to:
allow the low-priority client to retransmit a communication message for a response or change the client to perform the diagnosis request to another client when the communication message for the response is not received within a predetermined amount of time.

10. The vehicle diagnostic communication apparatus of claim 1, wherein the extended addressing-based CAN frame comprises:
a priority, an extended data page, a basic data page, a Protocol Data Unit (PDU) format, a destination address, and the source address.

11. The vehicle diagnostic communication apparatus of claim 1, wherein the extended address-based CAN frame is 29 bits, and a general address-based CAN frame is 11 bits.

12. A vehicle system comprising:
a gateway configured to convert a general address-based control area network (CAN) frame into an extended address-based CAN frame including a source address in a CAN communication-based multi-client diagnosis environment; and
a vehicle diagnostic communication apparatus configured to generate a communication message for a diagnosis request based on the extended address-based CAN frame received from the gateway.

13. The vehicle system of claim 12, wherein the gateway is configured to:
store priority information in a 26-th bit to a 28-th bit of the extended address-based CAN frame by using information in an 8-th bit to a 9-th bit of the general address-based CAN frame;
store a destination address in an 8-th bit to a 15-th bit of the extended address-based CAN frame by using information in a 0-th bit to a 7-th bit of the general address-based CAN frame; and
convert the general address-based CAN frame into the extended address-based CAN frame.

14. The vehicle system of claim 13, wherein the gateway is configured to:
store ‘0 (zero)’ in a 24-th bit and a 25-th bit of the extended address-based CAN frame;
store ‘218’ or ‘219’ in a 16-th to a 23-th bit; and
store the source address in the 0-th bit to the 7-th bit.

15. A vehicle diagnostic communication method comprising:
generating and transmitting a communication message for diagnosis request based on an extended address-based control area network (CAN) frame including a source address in an CAN communication-based multi-client diagnosis environment;
identifying a client that transmits the communication message based on the source address when receiving the communication message; and
transmitting a response message to the client that transmits the communication message.

16. The vehicle diagnostic communication method of claim 15, further comprising:
converting a general address-based CAN frame into the extended address-based CAN frame when receiving the general addressing-based CAN frame for the diagnosis request.

17. The vehicle diagnostic communication method of claim 15, further comprising:
performing a diagnosis in order of priority when simultaneously receiving diagnosis requests from a plurality of clients or receiving a diagnosis request from another client while performing a previous diagnosis when receiving the communication message.

18. The vehicle diagnostic communication method of claim 17, further comprising:
storing the priority for the multi-client in advance.

19. The vehicle diagnostic communication method of claim 17, wherein performing the diagnosis in the order of the priority comprises:
disregarding a diagnosis request for a low-priority client when the low-priority client makes the diagnosis request while the diagnosis request is received from a high-priority client and a diagnosis is performed.

20. The vehicle diagnostic communication method of claim 19, wherein performing the diagnosis in the order of the priority comprises:
retransmitting a communication message for a response or changing, by the low-priority client, the client to perform the diagnosis request to another client when the communication message for the response is not received within a predetermined amount of time.
